(19) United States
(12) Patent Application Publication
(10) Pub. No.: US 2007/0190225 A1
(43) Pub. Date: Aug. 16, 2007

(54) Process for producing sausage from fish

(75) Inventor: Alexander Gruzman, Holon (IL)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Gloden Silver Fish LTD., Holon (IL)

(21) Appl. No.: 10/589,441

(22) PCT Filed: Feb. 15, 2005
(86) PCT No.: PCT/IL05/00192

§ 371 Date: Jan. 24, 2007

(30) Foreign Application Priority Data
Feb. 16, 2004 (IL) 160428

(51) Int. Cl. A23L 1/325

(52) U.S. Cl. 426/643

(57) ABSTRACT

Process for producing sausage-like product from fish, in which ingredients are added to a chunk of fish meat, for achieving maximum preservation of the unchanged anatomy and form of the tissue of the chunk, either before or after inserting the chunk into a tumbler. The chunk is tumbled in the tumbler for a predetermined period of time, so as to increase the level of absorbing of the ingredients in the chunk of fish.

### FIELD OF THE INVENTION

The present invention relates to the field of aquatic product process. More particularly, the invention relates to a process for making sausage-like fish product, similar to pastrami, wiener or the like.

### BACKGROUND OF THE INVENTION

Fish sausage is a kind of aquatic product with high nutritive value. The conventional methods for processing “fish meat” include dry salting and smoking, tinning, etc, or proceeding refrigeration transportation to meet the needs of the people who live in places where there are no aquatic products. Unfortunately, the production of sausages from whole fish, fish fillets or chunk of fish is problematic. The problems arise from the unique texture of the fish tissue, its chemical and physical components and properties, such as their high moisture content and fine fibers.

Further problems and drawbacks also exist due to the weakness, instability and brittleness of the “fish meat”. Unlike the process for production of meat sausages the production of fish sausages is much more difficult, due to the fact that most types of “fish meat”, usually, falls apart and crumbles even in the first stages of production.

Today, there are known thousands species of fish from which about 1500 of them are used in the aquatic industry. The different species of fish can be classified according to characteristics such as, their geographic location in which they lived, the depth they lived in, the type of food they consume, their physiological condition (e.g., weight, protein, fat), etc. Such characteristics are directly influence texture of the fish tissue, its chemical and physical components and properties, such as their high moisture content, fine fibers, as well as the weakness, instability and brittleness of the “fish meat”.

In the prior art, many attempts have been made in order to produce sausages from fish. In most cases, the fish sausage is prepared from limited types of fish, preferably those fish whose physical structure is less brittle, such as Tuna, Nile Perch, Carp and the like. Usually, such fish sausage is produced by adding starch into a minced “fish meat”, then preparing the fish sausage by the conventional process of preparing sausage, such as described in Chinese patent CN 1,234,990, which disclosed a method for preparing a fish sausage. However, due the abovementioned problems, most of the produced fish sausages were not made from pure fish or even complete chunk of fish, but from minced fish, such as mixture of fish and other animal meat or fat (e.g., ham or pork fat).

All the methods described above have not yet provided satisfactory solutions to the problem of producing sausages from non minced fish meat, but from fish slices or chunks.

It is an object of the present invention to provide a process which overcomes the drawback of the unique difficult shape, and problematic texture of the fish tissue due to its high moisture content and fine fibers.

It is another object of the present invention to enable the production of sausages from many different types of fish.

It is another object of the present invention to keep to the maximum, the original flavor of fish in the sausage, so the sausage of the present invention is more delicious and better in taste than the existing fish sausage prepared by minced fish meat and minced small fish. Thus the fish sausage will be a kind of true fish sausage that is tasty, and people can taste the presence of the fish.

Other objects and advantages of the invention will become apparent as the description proceeds.

### SUMMARY OF THE INVENTION

The present invention relates to a process for producing sausage-like product from fish, which comprises: a) providing a chunk of fish meat, preferably after removing unwanted or inedible parts from it, such as head, gut, scale and bones; b) adding ingredients to the chunk of fish for achieving maximum preservation of the unchanged anatomy and form of the tissue of that chunk, either before or after inserting it into a suitable blender, such as a tumbler or the like; and c) tumbling, for a predetermined period of time, the chunk of fish in the tumbler, thereby increasing the level of absorbing of the ingredients in the chunk of fish. Hereinafter, and unless otherwise stated, the product obtained from said process is a sausage-like fish product consisting of a complete chunk of fish, which is not minced.

According to one preferred embodiment of the invention, the process further comprises, prior to the insertion of the chunk of fish in to the tumbler, inserting the chunk of fish into a holding sleeve for achieving further preservation of the unchanged anatomy and form of the tissue of the provided chunk of fish, thereby aiding the meat of the chunk of fish from crumbling or falling apart.

According to one preferred embodiment of the invention, the ingredients are added to the provided chunk of fish by injecting them into it. Preferably, the ingredients further used for curing the chunk of fish.

According to a preferred embodiment of the invention, the process further comprises cleansing the obtained sausage-like fish product with cleansing material for removing unwanted residues that remained on its outer surface or on the sleeve. Preferably, the cleansing material is water.

According to another preferred embodiment of the present invention, the process further comprises, after cleansing the obtained product, transferring said product to a desired mold for thermally processing said product in said mold, thereby giving said product the shape of said mold.

According to yet another preferred embodiment of the present invention, the process further comprises, after completing the tumbling process, a) removing the holding sleeve from the product; and b) wrapping said product with wrapping material and inserting said wrapped product into an additional sleeve, said wrapping material is used for preventing the sticking of the additional sleeve to said product after thermally processing said product. Preferably, the wrapping material is porous paper or some other thin sheet of material permeable to air, for allowing smoke to pass through said wrapping material during the thermal processing.

Preferably, the process further comprises providing a tube for facilitating the insertion of the chunk into the holding sleeve, by, prior to the insertion of the chunk, placing said sleeve on said tube, in a way that said chunk is inserted through said tube.

At the same time, the invention has further scope and develops a new method for processing other aquatic products.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIGS. 1a to 1e schematically illustrate typical forms of fish chunks;

FIGS. 2a-c schematically illustrate the rolling of a fish chunk; and

FIG. 3 schematically illustrates the insertion of the chunk of FIG. 1b into a sleeve, according to one preferred embodiment of the present invention.

### DETAILED DESCRIPTION OF PREFERRED EMBODIMENTS

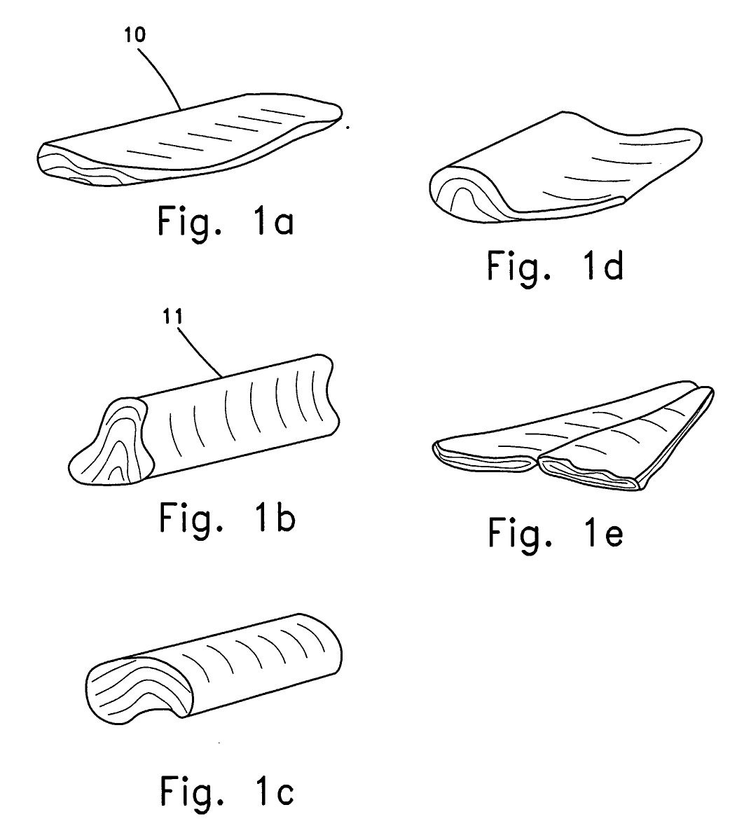

The process of the present invention enables the production of sausages from many different types of fish, such as Tuna, Nile Perch, Carp and the like. In particularly, the process enables the production of sausages from the problematic types of fish (i.e., the ones who their meat texture, chemical and physical components and properties are relatively further delicate). Preferably, but not limitatively, the sausages are produced from pieces, slices or chunks of fish after those chunks have undergone the process of cleaning, scaling and bone extraction. Size and shape of the chunks vary according to the size and shape of the fish. FIGS. 1a to 1e schematically illustrate typical forms of fish chunks. For example, FIG. 1b schematically illustrates a chunk of Tuna fish.

The purpose of the process of present invention is to maximize the preservation of the unchanged anatomy and form of the tissue of the fish. This ultimately allows the manufacture of a product which is firm, has taste and aroma which is unique, relatively easy to slice into slices, such as between 2-3 millimeter, 5-10 millimeter etc., depending on the type of fish and its anatomical makeup. According to a preferred embodiment of the present invention, the production of the sausage-like fish product is possible with or without the fish rind or skin. However, not removing the rind of the fish may further aid the preservation of the unchanged anatomy and form of the fish tissue.

According to a preferred embodiment of the invention, the process for producing a sausage-like product from fish meat comprises the steps of:
providing a chunk of fish meat, preferably after removing unwanted or inedible parts from it, such as head, gut, scale and bones;
adding ingredients to the chunk of fish for achieving maximum preservation of the unchanged anatomy and form of the tissue of that chunk, either before or after inserting it into a suitable blender, such as a tumbler or the like. Of course, the ingredients or their percentages may changed depending on the characters or properties of each type of fish; and
tumbling, for a predetermined period of time, the chunk of fish in the tumbler, for increasing the level of absorbing of the ingredients in the chunk of fish.

Hereinafter, and unless otherwise stated, the product obtained from the aforementioned process is a sausage-like fish product consisting of a complete chunk of fish (i.e., which is not minced).

According to one preferred embodiment of the invention, the process further comprises, prior to the insertion of the chunk of fish in to the tumbler, inserting the chunk of fish into a holding sleeve for achieving further preservation of the unchanged anatomy and form of the tissue of the provided chunk of fish, thereby aiding the meat of the chunk of fish from crumbling or falling apart. This is mostly useful when using a relatively delicate or problematic type of fish meat, as described hereinabove.

Preferably, the holding sleeve is used in order to prevent the mechanical breakdown of the “fish meat” (e.g., the chunk) in the different stages of the sausage production, especially during the first stages of production, as it is at the first stages of the production of sausages that the fish meat usually falls apart and crumbles. It should be noted that in the prior art no other meat products require these holding sleeves for production and processing.

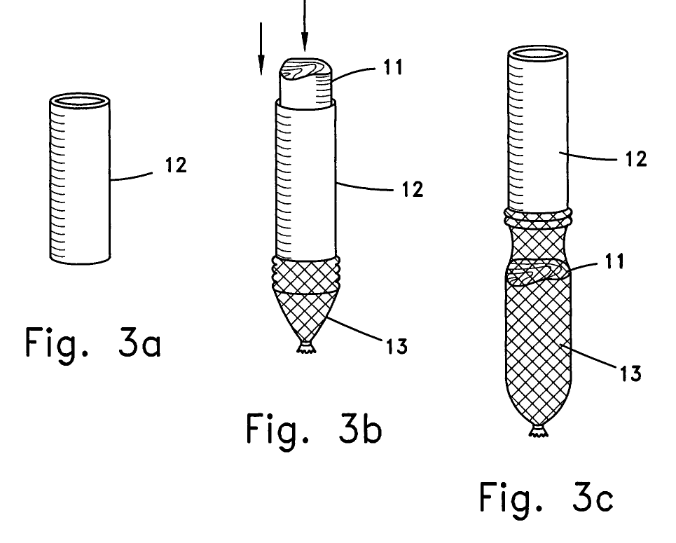

According to the shape of the fish (e.g., slice, fillet or slab) it is possible to seal it in a holding sleeve (e.g., as a flat slab or as a roll), as shown in accordance with FIG. 3. For example, a chunk of Tuna fish 11 (FIG. 1b and FIG. 3) can be easily inserted or packed into holding sleeve 13 (FIG. 3), other slices or chunks, such as those of Nile Perch 10 (FIG. 1a) can be rolled in order to make their insertion into sleeve 13 much easier.

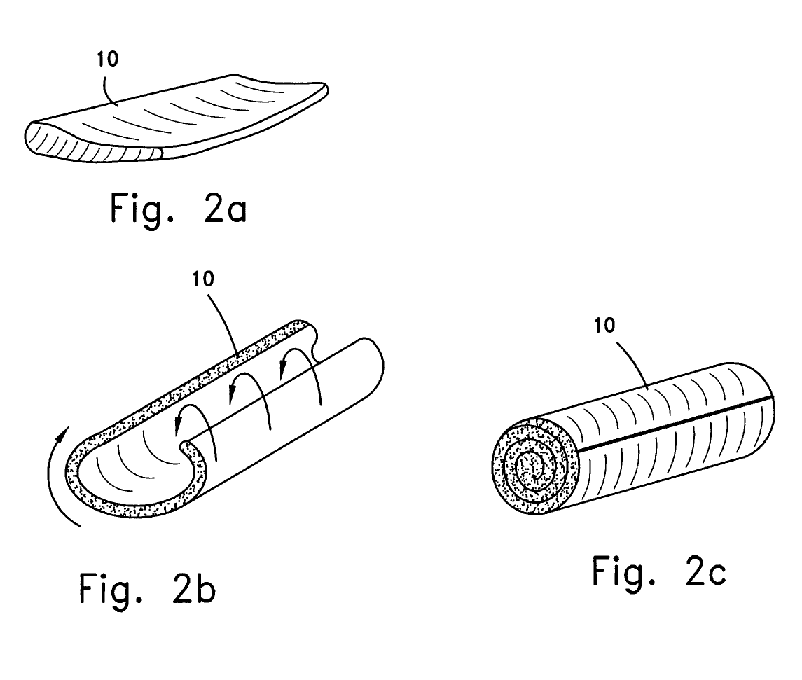

The rolling of slice 10 is demonstrated in FIGS. 2a-c, as follows:

Providing a slice of Nile Perch 10 (FIG. 2-a) and rolling it as demonstrated in FIG. 2-b, until a rolled slice is obtained (FIG. 2-c). Preferably, but not limitatively, the diameter of the rolled slice 10 should be approximately 50-100 mm and its length should be 50-70 cm, as it is most comfortable to work with pieces of 50-70 cm in length.

As aforementioned, the most comfortable sizes of fish slices to work with are between 50-70 mm up to 100-120 mm. Slices larger than this can be cut into the above-mentioned sizes. The length of the slice can vary from between 50-70 cm up to 1 meter. Although this is not critical, it is more comfortable to work with pieces of 50-70 cm in length.

According to another embodiment of the present invention, the process for producing sausages from fish, comprise the following steps:
providing a chunk of fish, preferably, after removing unwanted or inedible parts from said fish, such as head, gut, scale and bones. The chunk fish can be one or more slices of that fish or almost the entire fish as a whole.
inserting the provided chunk into a corresponding holding sleeve for achieving maximum preservation of the anatomic structure and form of the chunk. The insertion of the chunk into that sleeve results in preventing that chunk from crumbling or falling apart, as described hereinabove;
after the insertion of the chunk into the holding sleeve, different ingredients are injected or added to that chunk through that sleeve. The ingredients are used for curing or preserving the chunk, thereby allowing it a relatively long shelf life; and finally,
the injected chunk is processed or tumbled in a tumbler, for a predetermined time, for allowing the pores of the chunk to “open up” and accept the ingredients.

As a result of this process of the present invention, a sausage-like or pastrami-like fish product is obtained.

A typical vacuum tumbler comprises a drum into which the product is placed. Such typical tumblers work by removing the air from the drum and rotating or tumbling the product inside the drum. This creates a vacuum which allows the meat pores to “open up” and accept ingredients, such as brines and water. According to a preferred embodiment of the present invention, processing the injected amount of fish (i.e., the product) in a tumbler, the use of a vacuum is not necessary. The speed of the tumbler should be low and the processing period should be 2-4 hours according to the type and quality of the fish, and the size of the product. The tumbling process can be carried out either with or without generating a vacuum, or the vacuum can be generated in any desired intervals during the entire tumbling process (e.g., the tumbling process can be carried out in intervals of 10 minutes processing the product with vacuum and 20 minutes processing the product without vacuum). The processing of the product of the present invention can be executed in any suitable tumbler, such as the Biro DVTS-500 Vacuum Tumbler of Horizon Food Equipment.

Usually, in the tumbler, during the processing of the chunk the following occurs to it: chemical changes, extraction of protein for binding, improved texture and water retention. These processes strengthen the texture of the tissue and add elasticity to the chunk.

In order to facilitate the insertion of the slice of fish into the holding sleeve, a tube can be used, such as a solid plastic tube. After placing the sleeve on a solid plastic tube, the sleeve is sealed at one end and the raw material (e.g., chunk of fish or cleaned fish) is inserted through the tube, into the sleeve which is then closed at the other end. FIG. 3 schematically illustrates the insertion of chunk 11 into holding sleeve 13 while using a solid plastic tube 12. FIG. 3-a schematically illustrates the plastic tube 12. FIG. 3-b schematically illustrates holding sleeve 13 being placed on tube 12, in a way that the chunk of fish 11 can be inserted through the tube 13 into the holding sleeve 13. FIG. 3-c schematically illustrates the chunk of fish 11 after being completely inserted into holding sleeve 13 via tube 12.

It is preferable to use holding sleeves made from materials which can expand and be stretched to a desired size, such as fabric, netting or other elastic materials which can retain their properties, such as polyethylene or plastic.

Preferably, but not limitatively, the ingredients added to the chunk of fish 11 may comprise the following ingredients (per 100% of fish meat):

Water—10-40%

Nitrite salt (Salt with 6% NaNO₂)—0.2-0.3% (Used for color stabilization and preservation).

Salt—1.6-2% (Used for protein extraction and opening of pores).

Sugar—0.2-0.5% (Used for taste, oxidation inhibitor and as a base for biochemical reaction).

Phosphates—0.2-0.7% (Used for balance acidity, shape form, binding water, oxidation inhibitor and synergy of the remaining properties, such as of salts and carrageenans).

Ascorbate—0.05-0.1%

Sodium Glutamate—0.1-0.2%

Optionally, Natural and artificial flavorings may also be added to the fish meat, such as pepper, garlic, etc.

As aforementioned, the ingredients or their percentages may be changed depending on the characters or properties of each type of fish. For example, the above-mentioned ingredients can be used in order to provide a basic brine or marinade.

Depending on the type of fish, other selected quantities of added ingredients, as well as other ingredients can also be used, in order to achieve better preservation of the unchanged anatomy and form of the tissue of the chunk of fish. For example, in cases when producing a sausage-like fish product from relatively problematic “fish meat” (i.e., the fish meat is very weak, unstable, brittle etc.), an additional ingredient can be added to or injected into the fish meat for strengthening the tissue of the fish meat, such as suitable polysaccharides, stabilizers and the like.

A number of additional steps and options for the next stage of production may also take place, such as follows:
After the tumbling process the product can be extracted from the original sleeve and placed into a suitable casing for an alternative or more attractive appearance (e.g., by using typical filling or vacuum device);
Rinsing or cleansing the product to prevent sticking after thermal processing (i.e., cooking). For example, if using a plastic sleeve, it should be cleaned of any leakage of the product through the holes caused by the injection of the ingredients;
Sometimes, after the tumbling process, the sleeve expands and therefore it preferred that they will be refastened at both ends with sealing clips for aesthetic purposes;
If desired, after rinsing or cleansing the product, it can be transferred to a selected mold and the thermal processing can be continued within this mold. Placing the product within a mold having a specific form, results in giving the product essentially the same form or shape of the mold.

Preferably, but not limitatively, all products (i.e., all sausage-like fish products) obtained after the tumbling process, should be further thermally processed (e.g., “cooked” in a mold at about 74-78 degrees Celsius until the temperature inside the product is approximately 68-72 degrees Celsius). The final product, (i.e., the sausage-like fish product after the tumbling process), can be left as is, cooked, or may be smoked, before or after cooking. The thermal process is essentially used to achieve relatively low level of bacteria, which may result in relatively long shelf-life of the sausage-like fish product. Alternatively, the product can be frozen or smoked at high temperatures in order to obtain relatively long shelf-life.

After the cooking process, the product is cooled to room temperature and then transferred to a cooler. The temperature inside the product should then be between 2-8 degrees Celsius.

If required, vacuum sealing the final product is also an option.

As a result of the these stages of processing, including the cooking and cooling, the color and form of the final product is aesthetic, it is easy to slice with the aid of a slicing machine, and is juicy with a unique and novel taste and aroma.

According to another embodiment of the invention, instead of the thermal process, the fish product can be freeze shortly after completing the tumbling process.

The present invention overcomes the problems of the fish meat, being shaped difficultly, having fine fibers and more moisture content; and in addition, the present invention can be used on a large scale, as the source of the raw material used is broad, and it develops a novel approach for processing aquatic products.

The advantages of the present invention include: preserving the original flavor of the fish, keeping more of the taste of the fish and tasting better than conventional fish sausage made with minced “fish meat” and minced small fish. Therefore, the sausage-like fish product of the present invention is true “fish sausage” which is not only tasty but also people can taste the existence of the fish in it. This fills a vacancy in the market.

The present invention combines the advantages of tastefulness, high nutritive value from fish with the advantages of easy preservation, and mobility, convenience for eating, more unique in taste than conventional sausage, and provides a new convenience food. Furthermore, the present invention can provide different tastes due to different combinations of the materials, and can satisfy different demands of consumer. The present invention can solve the problem that some consumers like to eat fish but are not experts in cooking it. It also opens up another “convenience food product” for vegetarians who eat fish, but do not eat regular meat products.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1-17. (canceled)

18. A process for producing a sausage-like product from fish, comprising:
a) providing a chunk of fish meat;
b) providing a holding sleeve and a tumbler;
c) inserting said chunk of fish meat into said holding sleeve, for achieving maximum preservation of the anatomic structure and form of said chunk;
d) inserting said sleeve into said tumbler;
e) adding ingredients to said chunk, either before or after inserting said sleeve into said tumbler; and
f) tumbling, for a predetermined period of time, said sleeve in said tumbler, thereby increasing the level of absorption of said ingredients in said chunk of fish.

19. A process according to claim 18, wherein the ingredients are added to the chunk of fish by injecting them to said chunk.

20. A process according to claim 18, wherein the ingredients are used for curing the chunk of fish.

21. A process according to claim 18, wherein the ingredients are selected from the group consisting of: water, Nitrites, Salt, Sugar, Phosphates, Ascorbate, Sodium Glutamate, a stabilizer, or any combination thereof.

22. A process according to claim 21, wherein the stabilizer is a polysaccharide.

23. A process according to claim 18, further comprising cleansing or rinsing the product with cleansing material for removing unwanted residues.

24. A process according to claim 23, wherein the cleansing material is water.

25. A process according to claim 23, further comprising, after cleansing the product, transferring said product to a desired mold for thermally processing said product.

26. A process according to claim 25, further comprising:
a) after completing the tumbling process, removing the holding sleeve from the product; and
b) wrapping said product with wrapping material and inserting said wrapped product into an additional sleeve, said wrapping material being used for preventing the sticking of said additional sleeve to said product after thermally processing said product.

27. A process according to claim 26, wherein the wrapping material is porous paper or other thin sheet of material permeable to air.

28. A process according to claim 18, further comprising providing a tube for facilitating the insertion of the chunk of fish into the holding sleeve, and, prior to the insertion of said chunk into said holding sleeve, placing said holding sleeve about said tube in a way that said chunk is insertable into said holding sleeve through said tube.

29. A process according to claim 18, wherein the chunk of fish is provided after removing unwanted or inedible parts therefrom.

30. A process according to claim 18, wherein the chunk of fish is provided with its rind.

31. A process according to claim 18, wherein the chunk of fish is frozen after completing the tumbling process.

32. A process according to claim 18, wherein the holding sleeve is made of elastic material.
